(19) United States
(12) Patent Application Publication
(10) Pub. No.: US 2019/0285155 A1
(43) Pub. Date: Sep. 19, 2019

(54) TORQUE CONVERTER WITH IDENTICAL FORM FOR COVER, TURBINE AND PUMP SHELLS

(71) Applicant: SCHAEFFLER TECHNOLOGIES AG & CO. KG, Herzogenaurach (DE)

(72) Inventors: Pankaj Madhukar PATIL, Wooster, OH (US); Daniel SAYRE, Copley, OH (US)

(21) Appl. No.: 15/920,825

(22) Filed: Mar. 14, 2018

(51) Int. Cl. F16H 41/28; F16H 41/04

(52) U.S. Cl. CPC F16H 41/28; F16H 2041/243; F16H 41/04

(57) ABSTRACT

A torque converter comprising a cover that includes a cover-thickness defined by an outer peripheral surface and inner peripheral surface of the cover. The torque converter may also include a turbine shell that includes a turbine-shell thickness defined by a turbine-shell outer peripheral surface and turbine-shell inner peripheral surface, wherein the cover-thickness and the turbine-shell thickness are substantially identical.

### TECHNICAL FIELD

The present disclosure relates to torque converters and more specifically to the cover, impeller shell, and turbine shell for torque converters.

### BACKGROUND

In a torque converter, a cover, turbine, and pump may be the largest components. The tooling required to stamp the cover, turbine, and pump may consist of multiple die sets. The form in each of these components need to be very accurate to meet various requirements, thus tooling may be expensive. As additional tooling is needed for more components, expenses to create those components may increase. For example, it may be more expensive to stamp three components versus two components. In low volume production, the cost of tooling may not be justifiable as it is with high volume production.

### SUMMARY

According to one embodiment, a torque converter comprising a cover that includes a cover profile defined by the cover's contour, and an impeller shell that includes an impeller profile defined by an impeller contour, and wherein the impeller profile and cover profile includes a substantially identical contour.

According to a second embodiment, a torque converter includes a cover that includes a cover-thickness defined by an outer peripheral surface and inner peripheral surface of the cover. The torque converter further includes a turbine shell that includes a turbine-shell thickness defined by a turbine-shell outer peripheral surface and turbine-shell inner peripheral surface, wherein the cover-thickness and the turbine-shell thickness are substantially identical.

According to a third embodiment, a method of producing a torque converter is disclosed. The method includes tooling a cover for a torque converter from a first machine, tooling a turbine assembly for a torque converter from the first machine, and tooling an impeller assembly including for a torque converter from the machine, wherein the cover, turbine assembly, and impeller assembly each contain substantially identical contours.

### BRIEF DESCRIPTION OF THE DRAWINGS

FIG. 1 discloses a partial cross-sectional side view of a torque converter of the illustrative embodiment disclosed below.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In a torque converter, a cover, turbine shell, and impeller shell may be the largest components. The tooling required to stamp the cover, turbine assembly, and pump assembly may consist of multiple die sets. The form in each of these components need to be very accurate to meet various requirements, thus tooling may be expensive. As additional tooling is needed for more components, expenses may increase. For example, it may be more expensive to stamp three components versus two components. In low volume production (e.g. forklifts or construction vehicles), the cost may not be justifiable as with high volume products.

It may be feasible to utilize the same stamped form for a cover, turbine assembly, and impeller assembly. In such a situation, the outer diameter (OD) and inner diameter (ID) of each component could be machined or pierced based on the function and tolerance stacks. The torque converter may include a turbine core ring and an impeller core ring that may also utilize the same form. The same form can be utilized on both core rings to allow a communizing of the forming tool. If blades that are utilized on the impeller and turbine need different slots to accommodate for the blades, one die can be changed over to accommodate for such changes.

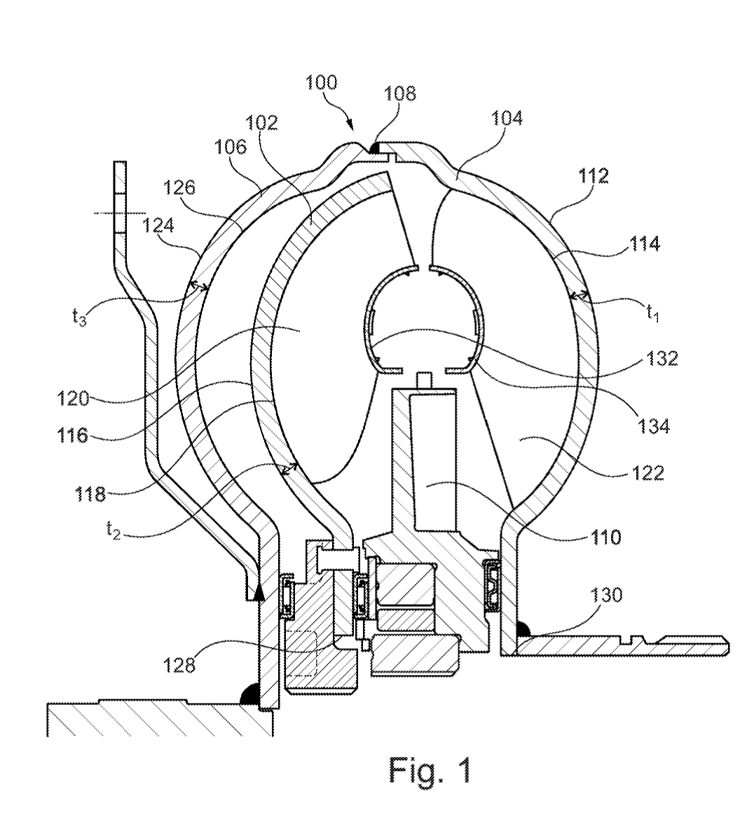

FIG. 1 discloses a partial cross-sectional side view of a torque converter 100 of the illustrative embodiment disclosed below. The torque converter 100 as disclosed in the embodiment of FIG. 1 may have components, such as the turbine shell 102, the impeller shell 104, and cover 106, that may have been manufactured from the same tooling. The torque converter 100 may include a cover 106 that may connect to a crankshaft of an internal combustion engine via a drive plate and a lug. The torque converter 100 may also include an impeller shell 104 for the impeller assembly 122. Impellers may also be referred to in the art interchangeably as a ‘pump’. The cover 106 and impeller shell 104 may be fastened together via a weld 108 during final assembly. The cover 106 may also be fixed to a cover pilot via a weld. The drive plate or studs may be welded directly on the cover 106 which eliminates any need of fasteners, such as extruded rivets, etc. Torque converter 100 also includes a turbine assembly 120, turbine shell 102, and stator 110 between the turbine 120 and impeller 122. The turbine assembly may include the turbine 120, turbine shell 102, and turbine core ring 132. The impeller assembly may include the impeller 122, impeller shell 104, and impeller core ring 134. Turbines and impellers may each include a plurality of blades in some embodiments.

Each of the shells may include an outer peripheral surface and an inner peripheral surface. For example, the impeller shell 104 may include an outer-peripheral surface 112 and an inner peripheral surface 114. The impeller shell 104 may include a thickness t1 that is defined between the impeller shell's inner peripheral surface 114 and outer peripheral surface 112. The turbine shell 102 may include an outer-peripheral surface 116 and an inner peripheral surface 118. The turbine shell 102 may include a thickness t2 that is defined by the turbine shell's inner peripheral surface 118 and outer peripheral surface 116. The cover shell 106 may include an outer-peripheral surface 124 and an inner peripheral surface 126. The cover shell 106 may include a thickness t3 between the cover shell's inner peripheral surface 126 and outer peripheral surface 124. In an embodiment of the torque converter 100 in FIG. 1, the shells for the cover, impeller, and turbine may have the same thickness. As such, thickness t1 of the impeller shell 104 would be identical to the thickness t2 of the turbine shell 102, which would also be identical to the thickness t3 of the cover.

In one embodiment, the cover 106, the turbine shell 102, and the impeller shell 104 may have a substantially identical form or profile. For example, the curvature, dimensions (e.g. length, breadth, depth, or height), shape, contour, etc., may be substantially identical for the cover 106, turbine shell 102, and impeller shell 104. For example, a cover of a torque converter may have a very unique shape compared to a turbine or impeller. But because the cover 106, turbine shell 102, and impeller shell 104 may be formed from the same tooling, the profile for these components will be substantially identical. The thickness, profiles, shapes, contour of these components being substantially identical may allow for each component to be substantially identical or have a very minor tolerance in variation. For example, the tolerance for thickness may be +/−0.35 mm. The tolerance for dimensions measured on the same side of the component or components may be +/−0.5 mm, e.g. measuring from a point on one side (e.g. inner surface) of the component a distance from that point to a furthest dimension of the same side (e.g. inner surface) of the component may a difference of +/−0.5 mm. The tolerance for dimensions measured on the opposite side of material thickness are +/−0.6 mm, e.g. measuring from a point on one side (e.g. inner surface side) the component a distance from that point to a furthest dimension of the opposite side (e.g. outer surface side) of the component may have a difference of +/−0.6 mm. Thus, this also allows for a tolerance for the curvature, profile, contour, etc. of the components to be substantially identical. Additionally, the cover 106, turbine shell 102, and impeller shell 104 may also be manufactured from the same material.

While the components of the turbine assembly, impeller assembly, cover may be manufactured substantially identically because they may be manufactured from the same tooling, machining (e.g. piercing, utilizing a die, etc.) may allow for slight variations of the finished torque converter components. As shown in FIG. 1, the inner diameter (ID) of the turbine shell ID 128 and impeller shell ID 130 may be pierced at different diameters. In an alternative embodiment, the ID 128 of the turbine shell 102 and the ID 130 of the impeller shell 104 may be pierced at the same diameters. The piercing of the turbine shell ID 128 and the impeller shell ID 130 may depend based upon requirements of the torque converter. For example, the transmissions may have different requirements with how the torque converter connects to the transmission and can be pierced accordingly. In an alternative embodiment, the turbine shell ID 128 and the impeller shell ID 130 may be machined rather than pierced, which may contribute to save on tooling investment.

Additionally, the turbine core ring 132 and the pump core ring 134 may have substantially identical forms or profiles. As shown in FIG. 1, the turbine core rings 132 and the impeller core ring 134 have the same form or profile. Thus, the turbine core ring 132 and the impeller core ring 134 may have the substantially identical dimensions, thickness, contour, material, etc. The core rings 132, 134 may include either substantially identical slots or different slots for the turbine blade tabs and the pump blade tabs. Thus, the slots may have a substantially identical location, size, circumference, diameter, etc. The tabs may be integral to the blades and provide a way for the blades to be attached to the core rings. The tabs may be bent after insertion through slots and serve to hold the blades to the front or outer surface of core rings. The core rings may hold the blades together for the impeller 122 and turbine 120. The tabs may further secure the blades to the core ring and are bent after insertion through corresponding slots. In some aspects, a notch in a blade may be positioned between adjacent tabs.

In one embodiment, the impeller 122 may include tab-less blades on the impeller shell 104 side. Because the blades may not have tabs, there may be no need for corresponding slots. The various components of the impeller assembly and turbine assembly may be glued together in such an embodiment. One of the stations for tooling may include a station that allows tooling the core rings differently to adapt for various slots that may be needed for the blades of the impeller. Thus, certain torque converters made in accordance to this disclosure may include the ability to have different core rings. For example, the turbine 120 may be stamped for blades at one machine and the impeller 122 may be stamped for blades at another machine. In such an example, blade configurations may be individualized for the turbine 120 versus the impeller 122. In another example, the turbine 120 and impeller 122 are stamped for blades at the same machine. Another station may also allow for the impressions for the blades to be made for the impeller 122. The stator 110 may also include blades.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LIST OF REFERENCE SYMBOLS

100 torque converter

102 turbine shell

104 impeller shell

106 cover

108 weld

110 stator

112 impeller outer peripheral surface

114 impeller inner peripheral surface

116 turbine outer peripheral surface

118 turbine inner peripheral surface

120 turbine

122 impeller

124 cover outer peripheral surface

126 cover inner peripheral surface

128 turbine shell inner diameter

130 impeller shell inner diameter

132 turbine core ring

134 impeller core ring

What is claimed is:

1. A torque converter comprising:
a cover that includes a cover profile defined by a cover contour; and
an impeller shell that includes an impeller profile defined by an impeller contour, and wherein the impeller profile and cover profile includes a substantially identical contour.

2. The torque converter of claim 1, wherein the torque converter includes a turbine shell including a turbine profile that is defined by a turbine contour, wherein the turbine profile is substantially identical to the impeller profile.

3. The torque converter of claim 2, wherein the impeller includes an impeller core ring and the turbine includes a turbine core ring, wherein the impeller core ring and turbine core ring include a substantially identical core-ring contour.

4. The torque converter of claim 3, wherein the impeller core ring and turbine core ring include different slots configured for blade tabs.

5. The torque converter of claim 1, wherein the impeller shell and the cover are made from the same material.

6. The torque converter of claim 1, wherein the impeller profile and the cover profile include a substantially identical thickness.

7. The torque converter of claim 1, wherein the impeller shell and the cover are from the same tooling.

8. The torque converter of claim 1, wherein an impeller shell thickness and a cover thickness are substantially identical.

9. The torque converter of claim 1, wherein an inner diameter of the impeller and an inner diameter of the cover have different diameters.

10. A torque converter comprising:
a cover that includes a cover-thickness defined by an outer peripheral surface and inner peripheral surface of the cover; and
a turbine assembly that includes a turbine shell that includes a turbine-shell thickness defined by a turbine-shell outer peripheral surface and turbine-shell inner peripheral surface, wherein the cover-thickness and the turbine-shell thickness are substantially identical.

11. The torque converter of claim 10, wherein the torque converter further includes an impeller assembly that includes an impeller shell including an impeller-shell thickness defined by an impeller-shell outer peripheral surface and impeller-shell inner peripheral surface, wherein the impeller-shell thickness and the cover-thickness are substantially identical.

12. The torque converter of claim 11, wherein the impeller assembly, the cover, and the turbine assembly are from the same tooling.

13. The torque converter of claim 10, wherein the cover includes a cover profile defined by a cover contour and the turbine shell includes a turbine profile defined by the turbine's contour, wherein the turbine profile and the cover profile are substantially identical.

14. The torque converter of claim 10, wherein the torque converter further includes an impeller assembly including an impeller core ring and the turbine assembly includes a turbine core ring, wherein the impeller core ring and the turbine core ring include substantially identical thicknesses.

15. The torque converter of claim 13, wherein the impeller assembly includes an impeller and the turbine assembly includes a turbine, wherein the impeller and the turbine include substantially identical contours.

16. The torque converter of claim 15, wherein the impeller and the turbine include different slots.

17. The torque converter of claim 15, wherein the impeller and the turbine include same slots.

18. A method of producing a torque converter, comprising:
tooling a cover for a torque converter from a first machine;
tooling a turbine assembly for a torque converter from the first machine; and
tooling an impeller assembly for a torque converter from the machine, wherein the cover, turbine assembly, and impeller assembly each contain substantially identical contours.

19. The method of claim 18, wherein the impeller assembly incudes an impeller and the turbine assembly includes a turbine, wherein the impeller is stamped for slots at a second machine and the turbine assembly is stamped for slots at a third machine.

20. The method of claim 18, wherein the impeller assembly incudes an impeller and the turbine assembly includes a turbine, wherein the impeller and the turbine are stamped for slots at a second machine.
